(19) United States
(12) Patent Application Publication
(10) Pub. No.: US 2023/0115586 A1
(43) Pub. Date: Apr. 13, 2023

(54) CONSTRUCTION METHOD OF DIGITAL TWIN FOR STRUCTURE PERFORMANCE OF INTELLIGENT EXCAVATOR

(71) Applicant: DALIAN UNIVERSITY OF TECHNOLOGY, Dalian, Liaoning (TW)

(72) Inventors: Xueguan SONG, Dalian, Liaoning (CN); Xiaonan LAI, Dalian, Liaoning (CN); Yanan ZOU, Dalian, Liaoning (CN); Xin WANG, Dalian, Liaoning (CN); Xiwang HE, Dalian, Liaoning (CN); Tianci ZHANG, Dalian, Liaoning (CN); Tao FU, Dalian, Liaoning (CN); Wei SUN, Dalian, Liaoning (CN)

(21) Appl. No.: 17/633,069

(22) PCT Filed: Oct. 8, 2021
(86) PCT No.: PCT/CN2021/122532

§ 371 Date: Feb. 4, 2022

(30) Foreign Application Priority Data
Jan. 27, 2021 (CN) 202110017331.6

(51) Int. Cl. G05D 1/00; G06F 30/23

(52) U.S. Cl. CPC G05D 1/0022; G05D 1/0055; G05D 1/0094; G06F 30/23; G05D 2201/0202

(57) ABSTRACT

A construction method of digital twin for structure performance of an intelligent excavator. Through the finite element analysis on key parts in the process of the intelligent excavator, the relevant structural mechanics performance is obtained; The important operating states of the key parts of the intelligent excavator in the excavation process are collected, and the key operating data are obtained through data processing and calculation; sensor data and an artificial intelligence algorithm are fused, and the structure performance of the parts of the intelligent excavator under multiple unknown working conditions is predicated by using a prediction model; and finally, the performance data information is modeled and rendered by computer graphics technology, to obtain a digital twin of the structure performance display of the intelligent excavator is obtained, thereby realizing digital twin mapping of the performance information on key parts of the intelligent excavator in the excavation process.

### TECHNICAL FIELD

The present invention belongs to the field of digital twin, and specifically is a construction method of digital twin for structure performance of an intelligent excavator.

### BACKGROUND

An intelligent excavator is a key device of open-pit mining and plays an important role in the mining of mineral resources. Due to a harsh working environment, high working intensity and long working time, there are potential structural failure risks. Moreover, once the structural failure occurs, it will bring great economic loss and even casualties. Therefore, in order to guarantee a safe and continuously stable operation of the intelligent excavator, it is necessary to conduct real-time monitoring for the structure performance of the intelligent excavator. With the rapid popularization and application of big data, Internet of Things, cloud computing and other new generation of information and communication technologies, the real application of the digital twin technology obtains a technical guarantee. The digital twin is a concept of virtuality and reality combination, and generally includes a physical entity, a virtual entity and connection there between. Using an idea of the digital twin, a system capable of high-fidelity description of a physical entity on multiple dimensions and time scales can be constructed, which can simulate, control and diagnose states and behaviors of the physical entity in a real environment in real time, and characterize some information that can not be directly observed. In order to conduct fusion of real dynamic operation data and virtual performance analysis data to realize the monitoring of a working state of the intelligent excavator during the operation, a digital twin system for real-time monitoring of the structure performance information on the intelligent excavator needs to be invented.

### SUMMARY

In the context of an increasing demand for the monitoring of structure performance of an intelligent excavator, the present invention proposes a monitoring method for the structure performance of the intelligent excavator based on a digital twin by comprehensively analyzing defects and deficiencies of a real-time calculation method of the existing structure performance, and by monitoring the structure performance of the intelligent excavator to construct the digital twin, integrates a physical geometry module, a communication module, an algorithm module and a real-time virtual display module, to realize the real-time monitoring display for the performance of parts of the intelligent excavator in the excavation process.

To achieve the above purpose, the present invention adopts the following technical solution:

a construction method of a digital twin for structure performance of an intelligent excavator, wherein the method is realized based on the combination of a digital twin system with a physical geometry module, a communication module, an algorithm module and a real-time virtual display module: firstly, in the physical geometry module, according to a real geometry of the intelligent excavator, planning each action unit of an excavation action, paying attention to space geometry positions and mutual cooperation relationship among parts, installing industrial sensors on the key monitored parts, and extracting input variables, to ensure the real-time capture of the excavation action; secondly, conducting data processing and fusion through a decoding system of the communication module, to conduct lightweight storage and transmission on the real-time motion data; once again, introducing data into an algorithm module to build a mathematical model, and constructing the corresponding mathematic relation between the physical motion information and the structure performance information; finally, introducing the structure performance information for rendering into the real-time virtual display module, to display the structure performance and an external motion behavior in the virtual twin on multiple terminal platforms; and storing the operating data via the data storage and management, to continuously correct the mathematical model in the algorithm module, thereby ensuring the high fidelity of the digital twin. The method comprises the following specific steps:

in a first step, for the intelligent excavator, a physical entity part of the digital twin system is constructed firstly via the physical geometry module. The physical geometry module contains a sensing unit, a control unit, a drive unit, and an action realization unit, specifically:

firstly, a working environment of the intelligent excavator is collected in real time. Through a three-dimensional (3D) scanner in the sensing unit, the three-dimensional solid model building of an excavated material pile is realized to facilitate the real-time observation of an excavating operation progress. Through the statics analysis on each key part of the intelligent excavator, such as bucket, big arm, gear, the key factors affecting the structure performance of the parts of the intelligent excavator are determined. The input variables of operation working conditions of the excavator in the excavation process and the performance information on a demand solution are extracted. Therefore, corresponding industrial sensors are arranged on the key parts to collect real-time operation working condition information.

Secondly, the excavation action is planned according to a concrete shape of the excavated material pile. The corresponding motion instruction is input into a single chip microcomputer of the control unit, the motion instruction plans the travel of a stepping motor and a rotary encoder in the drive unit, and the related parts in the action realization unit can be controlled to carry out the excavating operation according to the specified excavation tracks, to enable the intelligent excavator to excavate with smaller power consumption and larger fillability.

Finally, the monitoring of the three-dimensional space position and motion cooperation relationship of the entity model of each key part of the intelligent excavator in the excavating operation process is realized; and data information is provided for the model building in the subsequent real-time monitoring display module.

In a second step, the real-time operation working condition information on the key parts collected through the industrial sensors in the above physical geometry module is input into the communication module, and the real-time data collected by the industrial sensors are classified and distributed through various protocols and data cleaning and classification systems in the communication module. The intelligent excavator is equipped with an upper industrial personal computer with data storage, data processing and wireless communication functions, and the sensing unit, the control unit and the drive unit in the physical geometry module are in a wired connection with the upper industrial personal computer through a USB interface for storing the historical operating data and the real-time data collected through the industrial sensors into the upper industrial personal computer. The sensing unit, the control unit and the drive unit in the physical geometry module can be wirelessly connected with the upper industrial personal computer through a PC terminal. The above data are read, the data are processed through the data cleaning and classification system, and the data processed through different communication protocols are transmitted to different terminals, thereby realizing concise, lightweight and standardization transmission communication.

In a third step, a deep neural network method which has the advantage of accurate and fast prediction is selected through the algorithm module, to establish the correlation between the actual operation working conditions and the internal structure performance information on parts. Firstly, a training set and a test set required by a construction algorithm are selected to build a deep neural network model and test the precision of the deep neural network model respectively. The input working condition information determined by the static analysis in the physical geometry module is used as an input variable. An input working condition set representing the whole design space is uniformly selected, and the structural mechanics information corresponding to the input working condition set is solved by a finite element method to be used as an output variable. The deep neural network is built using the training set, and the correlation between the actual operation working conditions and the structural mechanics performance of the parts is constructed. The precision of the deep neural network model is tested by using the selected test set, and a determination coefficient R2 is selected as a model precision test index, to ensure the accuracy of the built model.

In a fourth step, the internal performance information on the parts is rapidly calculated according to the real-time operation working conditions transmitted by the communication module. On the basis of the deep neural network model in the third step, the operation working condition information on the intelligent excavator is collected in real time by using the industrial sensors arranged on the key parts, which is stored by the upper industrial personal computer arranged in the intelligent excavator through the communication module. At the PC terminal, wireless connection is used to communicate with the upper industrial personal computer. Through data cleaning and classification, the processed data is taken as input, the calculation is conducted by the deep neural network model, and the structural mechanics performance of the intelligent excavator under the current operation working conditions is solved. The data are connected with the real-time monitoring display module by using a Web Socket communication protocol.

In a fifth step, the three-dimensional rendering display is conducted on the performance information through the real-time monitoring display module. A browser is selected as a monitoring display platform, and a virtual three-dimensional scenario is constructed, to realize the intuitive and high-fidelity twin mapping of the structure performance of the intelligent excavator. Through a browser rendering engine, three. Js based on a WebGL standard is adopted as a scripting language for the three-dimensional rendering display, and the advantage is that underlying graphics hardware is used to speed up graphics rendering, achieving real-time display requirements, specifically:

firstly, the three-dimensional model of the parts is imported into the constructed virtual three-dimensional scenario in a GLTF format, and the three-dimensional space position of the parts in the physical geometry module and the information on the motion coordination among the parts are used to construct the initial three-dimensional display, realizing the motion synchronization between a virtual three-dimensional model and a real physical model.

Secondly, the structure performance information on the key parts is displayed, the model of the key parts is imported in a tetrahedral form, and the real-time performance information on the parts is calculated on a tetrahedral node through the deep neural network model of the algorithm module, to display the change to the structure performance in a three-dimensional cloud image form.

Finally, the UI interface planning of the real-time monitoring display module is realized, and operating limit positions of the parts are monitored in real time, thereby realizing timely warning and preventing accidents. Moreover, for the drawing of excavation tracks in the excavation process of the intelligent excavator, the virtual visualization excavating is realized.

The present invention has the following beneficial effects: the present invention realizes the real-time calculation of the internal structure mechanics performance of the parts by using a deep neural network algorithm and a sensor communication technology under multiple operation working conditions of the intelligent excavator, and evaluates, predicts and conducts feedback-based optimization for the performance of the intelligent excavator by combining the actual collected data. The present invention only uses a small amount of sensor information to realize the high-fidelity real-time display of the structure performance information on the intelligent excavator during the whole operating action period, and to realize the real-time monitoring for the performance of each key part of the intelligent excavator and prevent accidents.

### DESCRIPTION OF DRAWINGS

FIG. 1 is a framework diagram of a system of the present invention;

FIG. 2 is a schematic diagram of system building of the present invention;

FIG. 3 is a schematic diagram of an intelligent excavator of the present invention;

FIG. 4 is a schematic diagram of a communication technology of the present invention;

FIG. 5 is a schematic diagram of an algorithm module data fusion process of the present invention;

FIG. 6 is a schematic diagram of a twin display system of the present invention;

In the figures: 1 rotary body, 2 A-shaped frame, 3 large arm, 4 gear, 5 head sheave, 6 bucket.

### DETAILED DESCRIPTION

The technical solution of the present invention is further described below in detail in combination with the drawings and the specific embodiment which is described to only explain the present invention but not to limit the present invention.

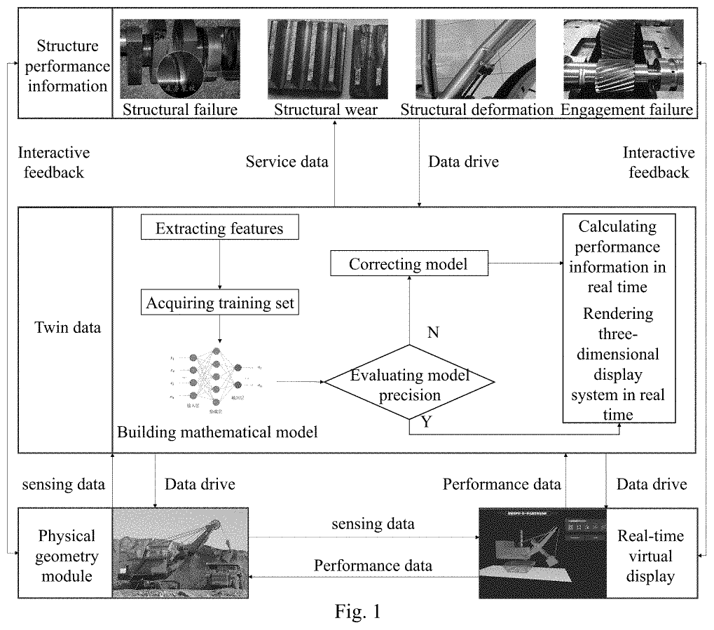

The present invention builds a digital twin for structure performance of an intelligent excavator. Referring to FIG. 1, FIG. 1 is a framework diagram of a digital twin system of the structure performance of an intelligent excavator. Based on a physical geometry module, a real-time virtual display platform that can reflect structure performance information is built. Driven by data, various structure safety problems such as structural fatigue, structural wear, structural deformation and meshing failure are solved, wherein the twin data are a bridge of interactive feedback between multiple modules. A training set is selected by feature extraction, and a deep neural network model is trained. The performance information on the intelligent excavator is calculated in real time by combining the sensing data. The visual display of the performance change is realized via the virtual display platform.

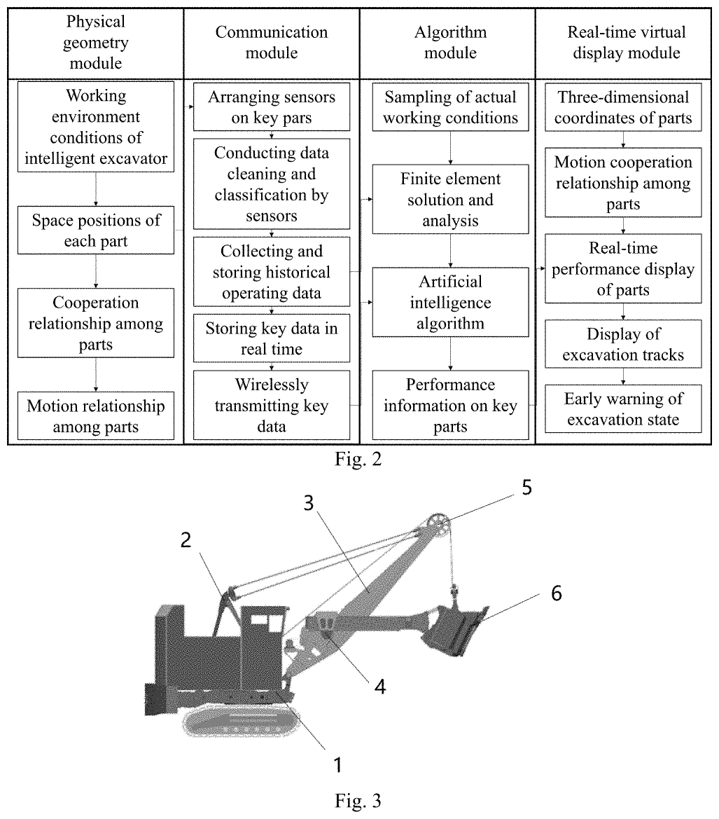

Referring to FIG. 2, FIG. 2 is a building flow of a digital twin system of the structure performance for an intelligent excavator based on a mathematical model and sensor communication technology provided by the present invention. The method needs to gradually build four main modules: a physical geometry module, a communication module, an algorithm module and a real-time virtual display module. The main steps comprise: firstly, in the physical geometry module, according to a real geometry of the intelligent excavator, planning each action unit of an excavation action, paying attention to space geometry positions and mutual cooperation relationship among parts; installing suitable sensors on the key monitored parts, and extracting input variables, to ensure the real-time capture of the excavation action; secondly, conducting data processing and fusion through a decoding system of the communication module, to conduct lightweight storage and transmission on the real-time motion data; introducing data into an algorithm module to build a mathematical model, and constructing, and constructing the corresponding mathematic relation between the physical motion information and the structure performance information; introducing the structure performance information for rendering into the real-time virtual display module, to display the structure performance and an external motion behavior in the virtual twin on multiple terminal platforms; and storing the operating data via the data storage and management, to continuously correct the mathematical model in the algorithm module, thereby ensuring the high fidelity of the digital twin.

The specific embodiments of the present invention will be further described below through the embodiments.

The establishment for the digital twin of the intelligent excavator is specifically taken as an example for illustration.

Taking the intelligent excavator as an object instance, referring to FIG. 3, FIG. 3 is a whole schematic diagram of an intelligent excavator. A big arm 3, a gear 4 and a bucket 6 are important parts of the structure performance testing of the intelligent excavator. During the motion of the intelligent excavator, three key actions of bucket lifting, bucket pushing and body rotating are mainly realized. Through the statics analysis, the bucket excavating load, the bucket lifting angle and the bucket pushing length are the input variables that can reflect the working conditions for excavation. Therefore, a rotary motor and a rotary encoder are installed on a rotary body 1 for collecting the information on a rotation angle in real time. A gear and racks are used to match and connect the big arm 3 and the bucket 6, and a lifting motor and the rotary encoder are installed for collecting the information on a lifting angle in real time. A tension and force sensor is installed at a lifting rope of the bucket 6 for collecting the bucket load in real time. The pushing length of the bucket can be calculated using an equivalent cosine law by a mathematic relation. To sum up, the building of the physical geometry module in the digital twin of the structure performance of the intelligent excavator is completed.

The communication module of the intelligent excavator is completed around the upper industrial personal computer installed in the excavator. Referring to FIG. 4, the industrial personal computer is a micro server based on a ROS system, and has a processor and a memory. A single chip microcomputer, a signal converter and a controller for controlling the motion of the intelligent excavator is connected with the industrial personal computer through a USB interface, to control the operation of the intelligent excavator according to the specified motion tracks, wherein the controller directly controls the operation of the intelligent excavator through the control of a stepping motor and a rotary encoder. In addition, the intelligent excavator supports manual control of excavation, and a control handle can be connected to the upper industrial personal computer through Bluetooth. The real-time data collected by sensors installed in the intelligent excavator, such as lidar, tension sensor and torque sensor, are stored by the upper industrial personal computer. A router is installed in the upper industrial personal computer, and a PC terminal communicates with the upper industrial personal computer in a WIFI wireless connection, to facilitate further cleaning and classification of the data collected by the sensors. The relevant performance information is transmitted via a WebSocket agreement, and can be visually output through the PC terminal, a monitoring display screen, a VR device, etc., to realize the real-time display of the performance of the intelligent excavator.

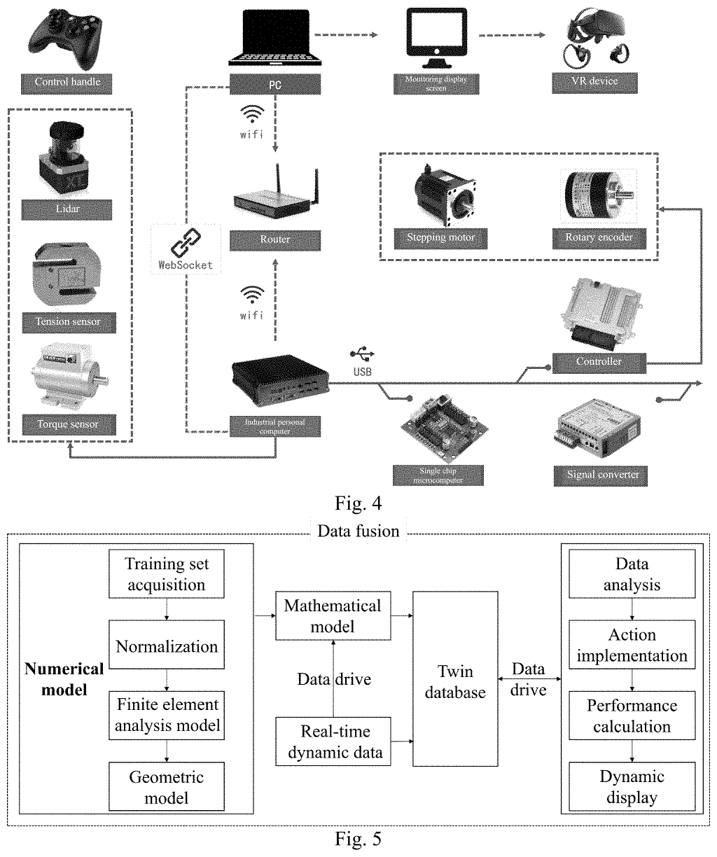

Referring to FIG. 5, FIG. 5 is a schematic diagram of a data fusion process of an algorithm module in a digital twin system, and illustrates a data processing and modeling process in the present invention in detail, which mainly includes an analysis process of a numerical model, a building process of the mathematical model, and a data storage process of a digital twin database. In the building process of the numerical model, based on the whole design space, a typical operating state is uniformly selected as an input variable of a training set, the mechanics performance of the structure thereof is calculated as the output of the training set, and the solution is determined through a finite element method by defining a unit type, the material and a boundary condition of the geometry. The deep neural network model is built by using the operating state of the numerical model and the information on the structural mechanics performance, to complete effective high-precision forecast for the structure performance information on the variables of the whole design space. When the operating data are transmitted, the structure performance information on the parts can be calculated in real time. The numerical model and the depth neural network model are used in the twin database for subsequent data analysis, operating action realization, performance calculation and dynamic three-dimensional display. To sum up, the building of the algorithm module in the digital twin of the structure performance of the intelligent excavator is completed.

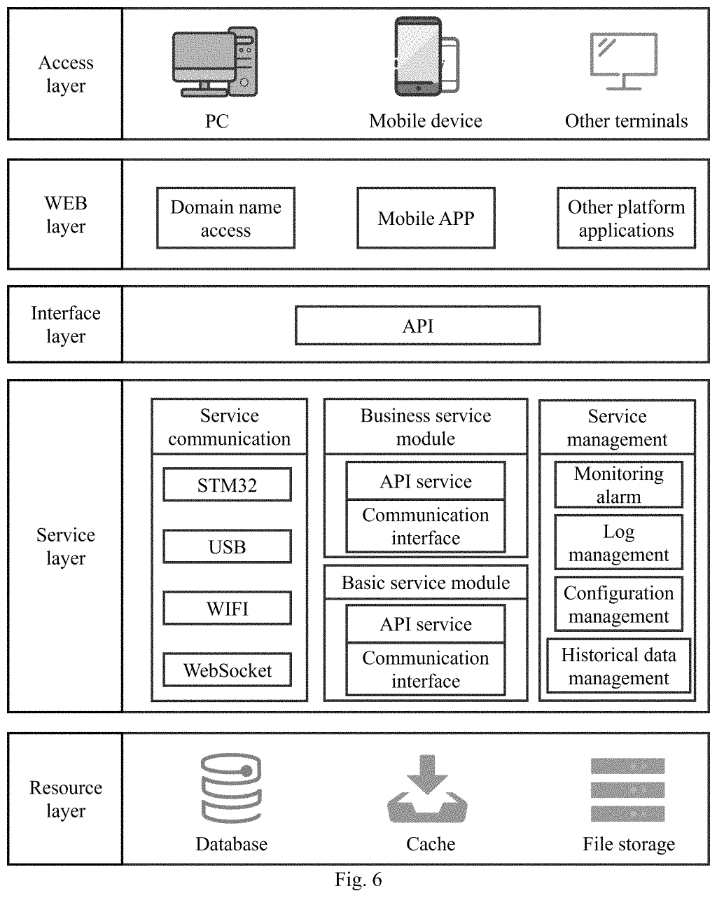

To sum up, by the related calculation information on the above physical geometry module and the algorithm module, the real-time virtual display module of the digital twin is built through data communication transmission in the communication module. In order to visually display the performance information of the intelligent excavator, a digital twin performance display platform is built by computer graphics technology. Referring to FIG. 6, FIG. 6 is a schematic diagram of a digital twin performance display platform of the present invention, and relates to a resource layer, a service layer, an interface layer, a web layer, and an access layer, wherein the resource layer includes simplified three-dimensional model information for constructing the digital twin, such as three-dimensional coordinates of parts, and motion cooperation relationship among parts; as well as real-time calculated data information on the structure performance through the algorithm module. At the same time, the resource layer has data storage and caching functions. The service layer comprises a communication module, a service module and a management module, and completes the information exchange between the digital twin display platform and other systems, and realizes service logic such as history excavation data management of the intelligent excavator, performance display human-computer interaction, monitoring alarm, etc. The real-time rendering display of the digital twin performance display system on each platform is realized through a computer graphics card related graphics interface API in the interface layer. In the present invention, the three-dimensional performance display of the digital twin system can be conducted by accessing domain names in a PC client, a web terminal and a mobile terminal, and at the same time, for the performance information on the intelligent excavator, the real-time feedback functions, such as key point chart monitoring, early warning of limit states, display of intelligent excavation tracks, etc., are realized.

Although the present invention is disclosed above through preferred embodiments, the above preferred embodiments are not used to limit the present invention. Any of those skilled in the art may make possible amendments and modifications to the above technical content of the present invention using the above disclosed method and technical contents without departing from the spirit and scope of the present invention. Thus, any simple amendment, equivalent change and modification made to the above embodiments according to the technical essence of the present invention without departing from the content of the technical solution of the present invention shall belong to the scope of the technical solutions of the present invention.

This description is merely the example of the implementation forms of the inventive concept. The protection scope of the present invention shall not be limited to the specific forms described in the embodiments, but shall also involve the equivalent technical means that can be contemplated by those skilled in the art according to the inventive concept.

1. A construction method of a digital twin for structure performance of an intelligent excavator, wherein the method is realized based on the combination of a digital twin system with a physical geometry module, a communication module, an algorithm module and a real-time virtual display module, comprising the following steps:
in a first step, for the intelligent excavator, constructing a physical entity part of the digital twin system via the physical geometry module, wherein the physical geometry module contains a sensing unit, a control unit, a drive unit, and an action realization unit; specifically:
firstly, collecting a working environment of the intelligent excavator in real time; Through a three-dimensional (3D) scanner in the sensing unit, realizing the three-dimensional solid model building of an excavated material pile, to facilitate the real-time observation of an excavating operation progress; Through the statics analysis on each key part of the intelligent excavator, determining the key factors affecting the structure performance of the parts of the intelligent excavator; extracting the input variables of operation working conditions of the excavator in the excavation process and performance information on a demand solution; arranging corresponding industrial sensors on the key parts to collect real-time operation working condition information;
secondly, planning the excavation action according to the concrete shape of the excavated material pile; inputting the corresponding motion instruction into a single chip microcomputer of the control unit, wherein the motion instruction plans the travel of a stepping motor and a rotary encoder in the drive unit, and the related parts in the action realization unit can be controlled to carry out the excavating operation according to the specified excavation tracks;
Finally, realizing the monitoring of the three-dimensional space position and motion cooperation relationship of the entity model of each key part of the intelligent excavator in the excavating operation process; and providing data information for the model building in the subsequent real-time monitoring display module;
in a second step, inputting the real-time operation working condition information on the key parts collected by the industrial sensor in the above physical geometry module into the communication module, and classifying and distributing the real-time data collected by the industrial sensor through the communication module; wherein the intelligent excavator is equipped with an upper industrial personal computer with data storage, data processing and wireless communication functions, connecting the sensing unit, the control unit and the drive unit in the physical geometry module with the upper industrial personal computer through a USB interface in a wired manner for storing the historical operating data and the real-time data collected through the industrial sensor into the upper industrial personal computer; wirelessly connecting with the upper industrial personal computer, reading the above data and processing, and transmitting the processed data to different terminals;
in a third step, establishing the correlation between the actual operation working conditions and the internal structure performance information on parts; firstly, selecting a training set and a test set required by a construction algorithm, to build a deep neural network model and test the precision of the deep neural network model respectively; using the input working condition information determined by the static analysis in the physical geometry module as an input variable; uniformly selecting an input working condition set representing the whole design space, and solving the structural mechanics information corresponding to the input working condition set by a finite element method to be used as an output variable; building the deep neural network using the training set, and constructing the correlation between the actual operation working conditions and the structural mechanics performance of the parts; testing the precision of the deep neural network model using the selected training set, and selecting a determination coefficient R2 as a model precision test index, to ensure the accuracy of the built model;
in a fourth step, rapidly calculating the internal performance information on the parts according to the real-time operation working conditions transmitted by the communication module; On the basis of the deep neural network model in the third step, collecting the operation working condition information on the intelligent excavator in real time by using the industrial sensors arranged on the key parts, which is stored by the upper industrial personal computer arranged in the intelligent excavator through the communication module; at the PC terminal, communicating with the upper industrial personal computer in a wireless connection, through data cleaning and classification, taking the processed data as input, calculating by the deep neural network model, and solving the structural mechanics performance of the intelligent excavator under the current operation working conditions; connecting the data with the real-time monitoring display module by using a Web Socket communication protocol;
in a fifth step, conducting the three-dimensional rendering display on the performance information through the real-time monitoring display module; selecting a browser as a monitoring display platform, and constructing a virtual three-dimensional scenario, to realize the intuitive and high-fidelity twin mapping of the structure performance of the intelligent excavator; Through a browser rendering engine, conducting the three-dimensional rendering display, specifically:
firstly, importing the three-dimensional model of the parts into the constructed virtual three-dimensional scenario in a GLTF format, and using the three-dimensional space positions of the parts in the physical geometry module and the information on the motion cooperation relationship among the parts to construct the initial three-dimensional display, thereby realizing the motion synchronization between a virtual three-dimensional model and a real physical model;
secondly, displaying the structure performance information on the key parts, importing the model of the key parts in a tetrahedral form, and calculating the real-time performance information on the parts on a tetrahedral node through the deep neural network model of the algorithm module, to display the change to the structure performance in a three-dimensional cloud image form; and
finally, realizing the UI interface planning of the real-time monitoring display module, and monitoring operating limit positions of the parts in real time, thereby realizing timely warning and preventing accidents; and moreover, for the drawing of excavation tracks in the excavation process of the intelligent excavator, realizing the virtual visualization excavating.
